(19) United States
(12) Patent Application Publication
(10) Pub. No.: US 2015/0132439 A1
(43) Pub. Date: May 14, 2015

(54) NOVEL BRANDED PET FOOD

(71) Applicant: Hua QIN, Liaocheng City (CN)

(72) Inventor: Hua QIN, Liaocheng City (CN)

(21) Appl. No.: 14/248,989

(22) Filed: Apr. 9, 2014

(30) Foreign Application Priority Data
Nov. 13, 2013 (CN) 201310565183.7

(51) Int. Cl. A23K 1/00; A23K 1/16; A23K 1/10

(52) U.S. Cl. CPC A23K 1/001; A23K 1/10; A23K 1/1603
USPC 426/72; 426/464; 426/646; 426/644; 426/645; 426/104

(57) ABSTRACT

The invention relates to a pet food, in particular to a novel branded pet food. The pet food is prepared by the following steps: finishing a fresh meat raw material; chopping the finished meat raw material into meat paste; uniformly mixing all ingredients and the meat paste raw material in sequence to serve as an initial material; forming the initial material manually or with a forming machine; steaming in a boiled water state; cooling and then coating in prepared feed liquor; drying until the moisture content is 22+/−2 percent; branding on the upper surfaces or on the upper and lower surfaces; cutting into products of a certain shape to obtain the novel branded pet food. The novel branded pet food provided by the invention is rational in technology and formula, and has excellent color, taste and texture on the basis of guaranteeing balanced nutrition of the product; the finished product has the color and the smoky incense of roast meat and moderate texture and is non-sticking; the coating and the brands make that the products have novel and unique appearances and strong visual impact, and overcome the defects of the conventional pet foods in the aspect.

### TECHNICAL FIELD

The invention relates to a pet food, in particular to a novel branded pet food.

### BACKGROUND OF THE INVENTION

At present, with the development of economy and the improvement of living standards, more and more people keep pets, and the demand for pet foods is increasing, at the same time, people increasingly discard the conventional ideas of just feeding up the pets in the diets of the pets and seek healthy, nutritional, fresh and interesting pet foods. The conventional pet foods or the common pet foods on the market are processed or compositely processed from main materials such as livestock meat, poultry meat, edible pig and cow skin, wheat flour and rice flour, occupy the markets for a long time and have the following characteristics that the change in shape is used as the main innovation point, the taste and the smell of the product are simple, the smoky incense which has great attraction to the pets cannot be reflected, the product has a single color, no layering sense, and extremely hard and brittle product texture, scraps are produced easily when the foods are eaten by the pets so as to cause waste and environmental pollution, or the pet foods are extremely soft and sticking and cause the halitosis and the oral diseases of the pets easily.

### SUMMARY OF THE INVENTION

The invention provides a fresh, interesting, nutritional and healthy novel branded pet food with good texture and strong layering sense and smoky incense, in order to overcome the defects in the background of the invention. The specific technical scheme is that:

A novel branded pet food, prepared by the following steps:

(1) finishing a fresh meat raw material, including defrosting (if necessary), cleaning, draining, weighing and the like;

(2) chopping the finished meat raw material into meat paste;

(3) placing the paste-shaped meat raw material in a stirrer to stir, slowly scattering an ingredient A therein, stirring for 5-10 minutes until to a uniform state and then slowly scattering an ingredient B, stirring for 3-5 minutes, adding glycerol and smoky powder, and then stirring all raw and auxiliary materials in the stirrer for 5-10 minutes to a uniform state to serve as the initial material;

(4) forming the initial material manually or with a forming machine into elongated products with smooth surfaces or wavelike concave convex upper surfaces, which are 0.5-1.2 cm in thickness, 10-50 cm in length and 2-6 cm in width;

(5) steaming in a steam box a boiled water state for 3-5 minutes;

(6) cooling and then dipping in prepared feed liquor C to fully coat a layer of feed liquor C on each elongated product;

(7) drying at 78-82 DEG C. until the moisture content is 22+/−2 percent;

(8) branding on the upper surface or on the upper and lower surfaces;

(9) cutting into elongated products or products of other shapes, which are 0.5-1.2 cm in thickness, 0.5-1.5 cm in width and 2-6 cm in length, to obtain the novel branded pet food.

The processing method can also comprise the following steps:

The fresh meat raw material is fresh chicken breast meat, duck breast meat, beef, mutton or pork.

The ingredient A comprises the following components in parts by mass: 0.1-0.3 parts of vitamin E, 3-5 parts of chicken fat oil, 0.2-0.3 part of potassium sorbate and 1.5-1.7 parts of water.

The ingredient A was in a uniformly stirred state before it is scattered into the stirrer.

The ingredient B comprises the following components in parts by mass: 25-30 parts of flour, 2.7-3.0 parts of common salt, 1.5-2.0 parts of monoglyceride, 1.0-1.2 parts of sodium tripolyphosphate, 0.7-1.0 part of citric acid, 0.3-0.4 part of garlic powder, 6-8 parts of sucrose and 7-10 parts of plant protein.

The plant protein comprises one or more than two of soybean protein concentrate, soybean protein isolate, textured soybean protein, pea protein, pea protein isolate, peanut protein, peanut protein isolate, corn protein and wheat protein.

The ingredient B can also comprise one or more than two of the following components in parts by mass: 2-4 parts of corn starch, 0.8-1.5 parts of sodium tripolyphosphate, 0.04-0.07 part of egg white powder, 1.5-2.5 parts of distilled glycerin monostearate and 1-2 parts of glucose.

The ingredient B was in a uniformly mixed state before it is scattered into the stirrer.

The glycerol and the smoky powder are 15-20 parts by mass and 0.1-0.2 part by mass respectively.

The ingredient A, the ingredient B, the glycerol and the smoky powder are uniformly scattered when added, and the stirrer is in a stirring state.

The feed liquor C comprises the following components in parts by mass: 4-6 parts of caramel pigment, 0.8-1.2 parts of egg white powder, 0.08-0.12 part of smoky powder, 0.2-0.4 part of guar gum and 80-100 parts of water.

The feed liquor C is one in a uniformly stirred state and contains no doughs, lumps or precipitates.

All the parts in the steps are parts by weight, wherein the fresh meat raw material is 100 parts.

The method can also comprise a step of drying at 95-105 DEG C. for 50-70 minutes to achieve the purpose of completer sterilization before the step of drying at 78-82 DEG C. until the moisture content is 22+/−2 percent.

The brands are grids or parallel lines which form an included angle of 45 degrees with the elongated products.

The products of other shapes comprise circular, square and fan-shaped products and products with cartoon animal shapes.

After the materials are cut into elongated products of products of other shapes, the remaining materials can be cut into dices as a pet treat for meal supplement, the food intake of the pet can be easily controlled, the pet food is nutritional and delicious, can meanwhile prevent the waste and is low-carbon and environment-friendly.

In the invention, the glycerol is used for moisturizing so as to keep the product soft and maintain the moisture; the chicken fat oil provides energy and increases the palatability; the sucrose, the common salt, the citric acid, the garlic powder and the smoky powder are used for flavoring; the sodium tripolyphosphate is used for reducing loss of soup during steaming; the distilled glycerin monostearate is used as an emulsifier to excellently mix various materials; the potassium sorbate is used as a preservative and can inhibit and kill bacteria; the vitamin E is used as an antioxidant for preventing oxidative deterioration of the chicken fat oil and meanwhile providing nutrition; the caramel pigment is used for adjusting the color of the products and improving the sensory characteristic of the product; the egg white powder is used as a gelling agent to improve the coating quantity of the product; the guar gum is used as a thickening agent to increase the coating quantity of the product.

The invention provides the novel branded pet food, which has the beneficial effects and advantages: the technology and the formula are rational, the technical formula has excellent color, taste and texture on the basis of guaranteeing the balanced nutrition of the product, the finished product has the color and the smoky incense of the roast meat, has stronger attraction to pets and moderate texture, is non-sticking and can prevent halitosis and oral diseases, and the coating and the brands make that the products have novel and unique appearances and strong visual impact and can meet the eating habits and the pursuit of new products of people and overcome the defects of the conventional pet foods in the aspect.

### DETAILED DESCRIPTION OF THE INVENTION

Detailed description is further made on the invention below in combination with the embodiments, those described below are only preferred embodiments of the invention, and various changes and modifications within the scope of the invention shall belong to the coverage of the invention.

### Embodiment 1

Weigh the ingredients: 0.1 part of vitamin E, 3 parts of chicken fat oil, 0.2 part of potassium sorbate and 1.5 parts of water, hold in a container and uniformly stir to serve as the ingredient A; weigh the ingredients: 25 parts of flour, 2.7 parts of common salt, 1.5 parts of monoglyceride, 1.0 part of sodium tripolyphosphate, 0.7 part of citric acid, 0.3 part of garlic powder, 6 parts of sucrose and 7 parts of plant protein, hold in a container and uniformly mix to serve as the ingredient B, wherein the selected plant protein is pea protein; weigh ingredients: 4 parts of caramel pigment, 0.8 part of egg white powder, 0.08 part of smoky powder, 0.2 part of guar gum and 80 parts of water, hold in a container and uniformly stir to serve as the feed liquor C; chop the 100 parts of weighed, cleaned and drained fresh chicken breast meat into meat paste, and hold in the stirrer to stir; slowly and uniformly scatter the ingredient A, stir for 5 minutes to a uniform state, slowly and uniformly scatter the ingredient B, stir for 3 minutes, then add 15 parts of glycerol and 0.1 part of smoky powder, and stir for 5 minutes to a uniform state to serve as the initial material; prepare the initial material into elongated products with smooth surfaces or wavelike concave convex upper surfaces, which are 0.5 cm in thickness, 10 cm in length and 2 cm in width, in the forming machine; steam in a steam box in a boiled water state for 3 minutes; cool and then dip in the prepared feed liquor C to fully coat a layer of feed liquor C on each elongated product; dry at 78 DEG C. until the moisture content is 22+/−2 percent; brand parallel lines which form an included angle of 45 degrees with the long edges of the elongated products on the lower surfaces by using a branding machine; cut into elongated products which are 0.5 cm in thickness, 0.5 cm in width and 2 cm in length to serve as the novel branded pet food.

### Embodiment 2

Weigh the ingredients: 0.3 part of vitamin E, 5 parts of chicken fat oil, 0.3 part of potassium sorbate and 1.7 parts of water, hold in a container and uniformly stir to serve as the ingredient A; weigh the ingredients: 30 parts of flour, 3 parts of common salt, 2 parts of monoglyceride, 1.2 part of sodium tripolyphosphate, 1 part of citric acid, 0.4 part of garlic powder, 8 parts of sucrose, 10 parts of plant protein, 3 parts of corn starch, 1.2 parts of sodium tripolyphosphate, 0.05 part of egg white powder, 2 parts of distilled glycerin monostearate and 1 parts of glucose, hold in a container and uniformly mix to serve as the ingredient B, wherein the plant protein is selected from pea protein, soybean protein isolate, peanut protein and wheat protein; weigh ingredients: 6 parts of caramel pigment, 1.2 parts of egg white powder, 0.12 part of smoky powder, 0.4 part of guar gum and 100 parts of water, hold in a container and uniformly stir to serve as the feed liquor C; chop the 100 parts of weighed, cleaned and drained fresh chicken breast meat into meat paste, and hold in the stirrer to stir; slowly and uniformly scatter the ingredient A, stir for 10 minutes to a uniform state, slowly and uniformly scatter the ingredient B, stir for 5 minutes, then add 20 parts of glycerol and 0.2 part of smoky powder, and stir for 10 minutes to a uniform state to serve as the initial material; prepare the initial material into elongated products with smooth upper and lower surfaces, which are 1.2 cm in thickness, 50 cm in length and 6 cm in width, in the forming machine; steam in a steam box in a boiled water state for 5 minutes; cool and then dip in the prepared feed liquor C to fully coat a layer of feed liquor C on each elongated product; dry in a drying box, which is preheated to 100 DEG C., for 60 minutes and then dry at 78 DEG C. until the moisture content is 22+/−2 percent; brand grid-shaped brands on the upper and lower surfaces by using a branding machine; cut into circular products to serve as the novel branded pet food.

### Embodiment 3

Weigh the ingredients: 0.2 part of vitamin E, 4 parts of chicken fat oil, 0.2 part of potassium sorbate and 1.6 parts of water, hold in a container and uniformly stir to serve as the ingredient A; weigh the ingredients: 28 parts of flour, 2.9 parts of common salt, 1.8 parts of monoglyceride, 1.1 part of sodium tripolyphosphate, 0.8 part of citric acid, 0.3 part of garlic powder, 7 parts of sucrose and 9 parts of plant protein, hold in a container and uniformly mix to serve as the ingredient B, wherein the plant protein is selected from soybean protein concentrate and corn protein; weigh ingredients: 5 parts of caramel pigment, 1 part of egg white powder, 0.1 part of smoky powder, 0.3 part of guar gum and 90 parts of water, hold in a container and uniformly stir to serve as the feed liquor C; chop the 100 parts of weighed, cleaned and drained fresh chicken breast meat into meat paste, and hold in the stirrer to stir; slowly and uniformly scatter the ingredient A, stir for 7 minutes to a uniform state, slowly and uniformly scatter the ingredient B, stir for 4 minutes, then add 17 parts of glycerol and 0.1 part of smoky powder, and stir for 7 minutes to a uniform state to serve as the initial material; prepare the initial material into elongated products with wavelike concave convex upper surfaces, which are 0.9 cm in thickness, 40 cm in length and 5 cm in width, in the forming machine; steam in a steam box in a boiled water state for 4 minutes; cool and then dip in the prepared feed liquor C to fully coat a layer of feed liquor C on each elongated product; dry at 80 DEG C. until the moisture content is 22+/−2 percent; brand parallel lines which form an included angle of 45 degrees with the long edges of the elongated products on the upper surface by using a branding machine; cut into square products to serve as the novel branded pet food.

1. A novel branded pet food, prepared by the following steps:
(1) finishing a fresh meat raw material, including cleaning, draining and weighing 100 parts of the fresh meat raw material;
(2) chopping the finished meat raw material into meat paste;
(3) placing the paste-shaped meat raw material in a stirrer to stir, slowly scattering an ingredient A therein, stirring for 5-10 minutes until to a uniform state and then slowly scattering an ingredient B, stirring for 3-5 minutes, adding glycerol and smoky powder, and then stirring all raw and auxiliary materials in the stirrer for 5-10 minutes to a uniform state to serve as the initial material;
(4) forming the initial material manually or with a forming machine into elongated products with smooth surfaces or wavelike concave convex upper surfaces, which are 0.5-1.2 cm in thickness, 10-50 cm in length and 2-6 cm in width;
(5) steaming in a steam box a boiled water state for 3-5 minutes;
(6) cooling and then dipping in prepared feed liquor C to fully coat a layer of feed liquor C on each elongated product;
(7) drying at 78-82 DEG C. until the moisture content is 22+/−2 percent;
(8) branding on the upper surface or on the upper and lower surfaces;
(9) cutting into elongated products or products of other shapes, which are 0.5-1.2 cm in thickness, 0.5-1.5 cm in width and 2-6 cm in length, to obtain the novel branded pet food.

2. The novel branded pet food according to claim 1, wherein the fresh meat raw material is fresh chicken breast meat, duck breast meat, beef, mutton or pork.

3. The novel branded pet food according to claim 1, wherein the ingredient A comprises the following components in parts by mass: 0.1-0.3 part of vitamin E, 3-5 parts of chicken fat oil, 0.2-0.3 part of potassium sorbate and 1.5-1.7 parts of water.

4. The novel branded pet food according to claim 1, wherein the ingredient B comprises the following components in parts by mass: 25-30 parts of flour, 2.7-3.0 parts of common salt, 1.5-2.0 parts of monoglyceride, 1.0-1.2 parts of sodium tripolyphosphate, 0.7-1.0 part of citric acid, 0.3-0.4 part of garlic powder, 6-8 parts of sucrose and 7-10 parts of plant protein.

5. The novel branded pet food according to claim 1, wherein the ingredient B can also comprise one or more than two of the following components in parts by mass: 2-4 parts of corn starch, 0.8-1.5 parts of sodium tripolyphosphate, 0.04-0.07 part of egg white powder, 1.5-2.5 parts of distilled glycerin monostearate and 1-2 parts of glucose.

6. The novel branded pet food according to claim 1, wherein the glycerol and the smoky powder are 15-20 parts by mass and 0.1-0.2 part by mass respectively.

7. The novel branded pet food according to claim 1, wherein the feed liquor C comprises the following components in parts by mass: 4-6 parts of caramel pigment, 0.8-1.2 parts of egg white powder, 0.08-0.12 part of smoky powder, 0.2-0.4 part of guar gum and 80-100 parts of water.

8. The novel branded pet food according to claim 1, wherein the brands are grids or parallel lines which form an included angle of 45 degrees with the elongated products.

9. The novel branded pet food according to claim 1, wherein the products of other shapes comprise circular, square and fan-shaped products and products with cartoon animal shapes.

10. The novel branded pet food according to claim 4, wherein the plant protein comprises one or more than two of soybean protein concentrate, soybean protein isolate, textured soybean protein, pea protein, pea protein isolate, peanut protein, peanut protein isolate, corn protein and wheat protein.
